(19) United States
(12) Patent Application Publication
(10) Pub. No.: US 2012/0224513 A1
(43) Pub. Date: Sep. 6, 2012

(54) System and Method for Making Simultaneous Outbound Calls Using DTMF Tones

(75) Inventors: Paul Steven Mahler, Woodland, CA (US); William N. Eck, Redwood City, CA (US); Edward De Jong, Oakland, CA (US)

(73) Assignee: VOICE CARRIER LLC, San Jose, CA (US)

(21) Appl. No.: 13/039,313

(22) Filed: Mar. 3, 2011

(51) Int. Cl. H04L 12/16

(52) U.S. Cl. 370/260; 370/259

(57) ABSTRACT

The present invention enables the user of a VOIP device to place simultaneous calls to multiple users and invite them to a conference using a pre-defined code. In a preferred embodiment, the user can customize a dynamic two digit code and associate a list of phone numbers with it.

The present invention does away with the need to use a ‘*’ or a ‘#’ as a prefix when initialing a control code call. Therefore, if the user wants the phone to do something, i.e., call forwarding, hold, block number etc, the user no longer has to press ‘*98’. The user can simply input 98 and the system will recognize it as a control code call command. The system accomplishes this task by determining a pre-determined amount of time that has passed after the user entered the last phone digit. In a preferred embodiment, the system waits for two seconds and then understands that the call is a control code call, matches the control code with the control codes associated with the database on the server and responds with the desired action associated with the control code call.

### COPYRIGHT NOTICE

A portion of the disclosure of this patent document may contain material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates to telecommunications. In particular, it relates to telecommunications and data services provided over Voice Over Internet Protocol (VOIP).

Telephony has become a necessity in today's times. From big corporations to small businesses to individual subscribers, every entity needs phone systems and to be seamlessly connected. Especially the limitations of phones in doing effective conference calling are very frustrated for users. For example, an administrator has to be present for the conference call and wait for other people on the conference call to dial in. If a family member wishes to talk to all family members at once, then it becomes even more difficult to accomplish this task. A series of ten digit numbers need to be dialed per person who is invited to the conference call. This can be a tedious task which can get even worse if someone dials the wrong number by even one digit. Another possible scenario that can be envisioned is that charity organizations or small community groups need to connect on a regular basis. It is tedious for groups to connect using the current conference calling system.

A telephone numbering plan is a type of numbering scheme used in telecommunications to allocate telephone numbers to subscribers and to route telephone calls in a telephone network. A closed numbering plan, such as found in North America, imposes a fixed total length to numbers. An open numbering plan features variance in the length of telephone numbers.

On the other hand, adial plan establishes the expected number and pattern of digits for a telephone number. This includes country codes, access codes, area codes and all combinations of digits dialed. For instance, the North American public switched telephone network (PSTN) uses a 10-digit dial plan that includes a 3-digit area code and a 7-digit telephone number. Most PBXs support variable-length dial plans that use 3 to 11 digits. Dial plans must comply with the telephone networks to which they connect.

The present system has many disadvantages. For example, when a user has to call several people who have ten digit phone numbers, even a single mistype on the phone dial can lead to severe frustration. This problem is compounded when the user regularly calls the same group of people together such as family members, common organizations etc. It becomes frustrating for the user to call five people separately or wait for everyone to dial in.

Another problem in the current system is that in order to make the user's phone system perform a command function using a control plane calling code, such as call forwarding or call waiting, the user has a dial a prefix such as “*” or “#” and then a set of two digit or three digit numbers. This approach is frustrating for the user because it is hard to remember the various prefixes and the numbers that they follow.

An opportunity arises to develop a system that is more group call friendly and does away with these obvious disadvantages of the current system. Also another opportunity arises to develop control plane calling codes that do away with the necessity of ‘#’ or ‘*’ as prefixes.

### SUMMARY OF THE INVENTION

The present invention enables the user of a VOIP device to place simultaneous calls to multiple users and invite them to a conference using a pre-defined code. In a preferred embodiment, the user can customize a dynamic two digit code and associate a list of phone numbers with it.

The present invention does away with the need to use a ‘*’ or a ‘#’ as a prefix when initialing a control code call. Therefore, if the user wants the phone to do something, i.e., call forwarding, hold, block number etc, the user no longer has to press ‘*98’. The user can simply input 98 and the system will recognize it as a control code call command. The system accomplishes this task by determining a pre-determined amount of time that has passed after the user entered the last phone digit. In a preferred embodiment, the system waits for two seconds and then understands that the call is a control code call, matches the control code with the control codes associated with the database on the server and responds with the desired action associated with the control code call.

### BRIEF DESCRIPTION OF THE DRAWINGS

FIG. 1 is a block diagram illustrating prior art PBX system.

FIG. 2 illustrates a prior art conference calling model.

FIG. 3 illustrates the logic based on which the system operates.

FIG. 4 illustrates an example of how a user may simply connecting to multiple groups.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

FIG. 1 is a block diagram illustrating a prior art PBX. It is important to understand the PBX in its current technological state. Traditionally, a private branch exchange (PBX) is a telephone exchange that serves a particular business or office, as opposed to one that a common carrier or telephone company operates for many businesses or for the general public. PBXs are also referred to as: PABX—private automatic branch exchange or EPABX—electronic private automatic branch exchange

PBXs make connections among the internal telephones of a private organization—usually a business—and also connects them to the public switched telephone network (PSTN) via trunk lines. Because they incorporate telephones, fax machines, modems, and more, the general term “extension” is used to refer to any end point on the branch.

Initially, the primary advantage of PBXs was cost savings on internal phone calls: handling the circuit switching locally reduced charges for local phone service. As PBXs gained popularity, they started offering services that were not available in the operator network, such as call forwarding, and extension dialing. System components

A PBX will often include: The PBX's internal switching network; Microcontroller or microcomputer for arbitrary data processing, control and logic; Logic cards, switching and control cards, power cards and related devices that facilitate PBX operation; Stations or telephone sets, sometimes called lines; Outside telco trunks that deliver signals to (and carry them from) the PBX; Console or switchboard allows the operator to control incoming calls; Uninterruptible power supply (UPS) consisting of sensors, power switches and batteries; Interconnecting wiring; Cabinets, closets, vaults and other housings.

Functionally, the PBX in FIG. 1 performs four main call processing duties: Establishing connections (circuits) between the telephone sets of users (e.g. mapping a dialed number to a physical phone, ensuring the phone isn't already busy); Maintaining such connections as long as the users require them (i.e. channeling voice signals between the users); Disconnecting those connections as per the user's requirement; Providing information for accounting purposes (e.g. metering calls). In addition to these basic functions, PBXs offer many other calling features and capabilities, with different manufacturers providing different features in an effort to differentiate their products. Common capabilities include (manufacturers may have a different name for each capability): Auto attendant. Auto dialing, Automatic call distributor; Automated directory services (where callers can be routed to a given employee by keying or speaking the letters of the employee's name); Automatic ring back, Call accounting, Call blocking, Call forwarding on busy or absence, Call park, Call pick-up, Call transfer, Call waiting, Custom greetings, Customized Abbreviated dialing (Speed Dialing) and Conference Call.

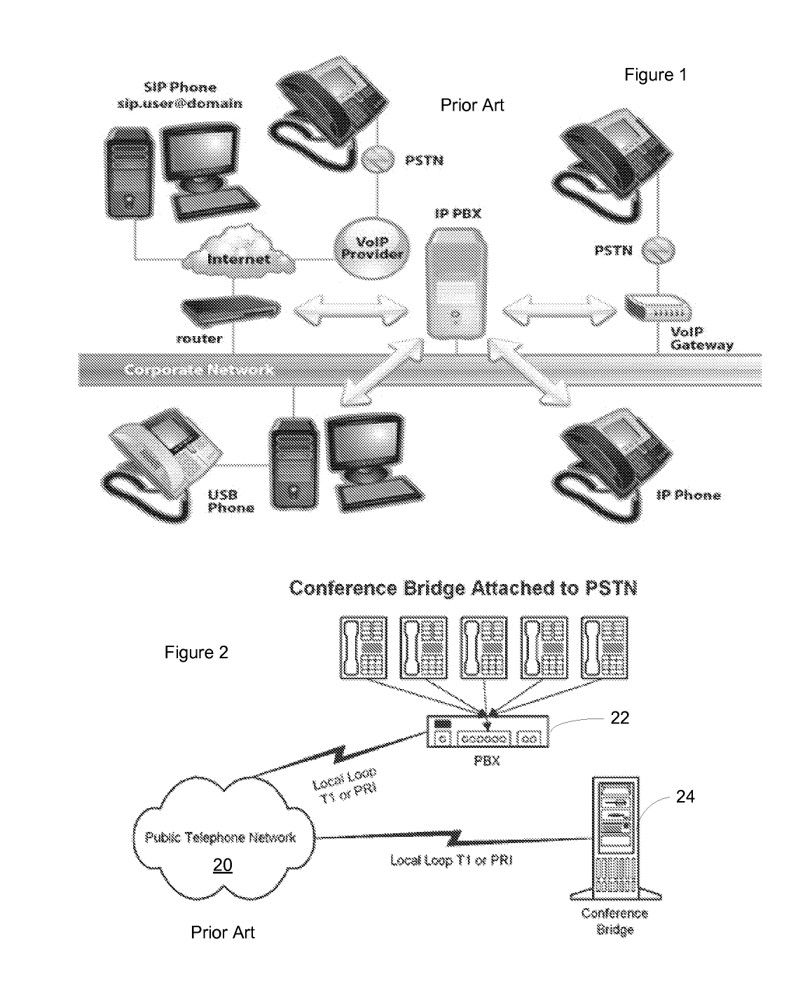

FIG. 2 is a prior art illustration of conference calling using a PBX. A conference call is defined as a telephone call in which the calling party wishes to have more than one called party involved in the call. Conference calls can be designed so that the calling party calls the other participants and adds them to the call—however, participants are usually able to call into the conference call themselves, by dialing into a special telephone number that connects to a “conference bridge” (a specialized type of equipment that links telephone lines).

Companies commonly use a specialized service provider who maintains the conference bridge, or who provides the phone numbers and PIN codes that participants dial to access the meeting or conference call. The phones call the PBX 22 to connect to the Public Telephone Network 20. After the user enters a code or some form of identification, the user is brought onto the conference bridge 24 where he/she can connect with the members who are already signed in.

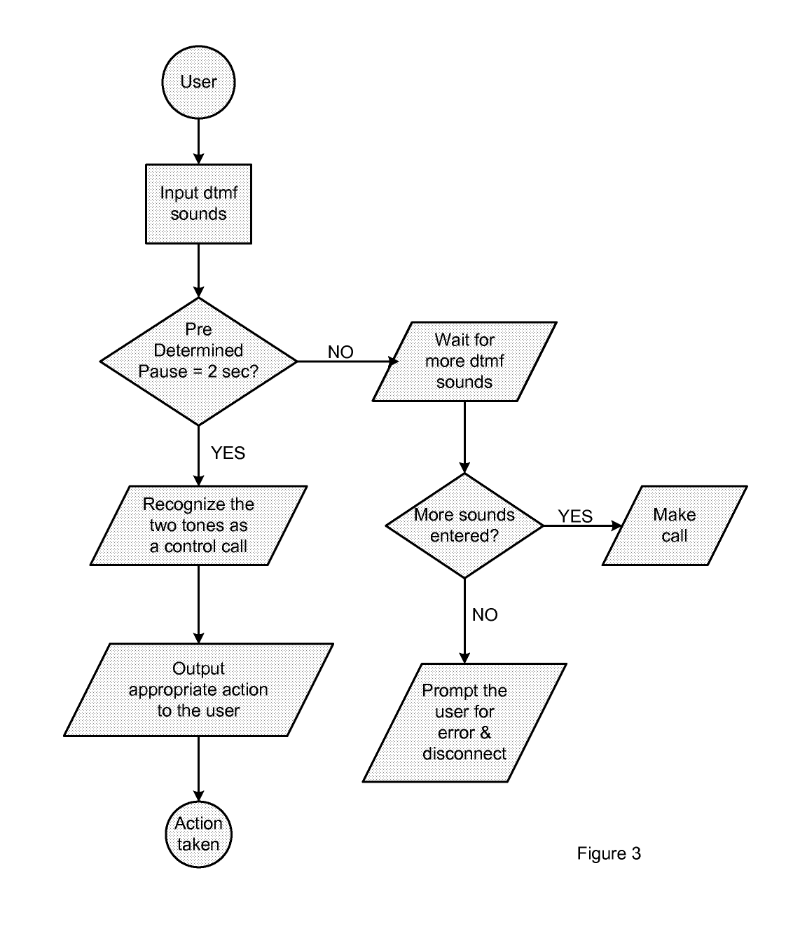

FIG. 3 is a block diagram illustrating logic of the present technological disclosure. The present disclosure includes a uniform dial plan that offers the same prompts for all customers. In a preferred embodiment, the real time dial plan directly connects to the switching engine. This means that all phone switching is based on customer configured database contents, and therefore all servers are identical. A control code call command is a special code dialed prior to a telephone number that engages some type of special telephone service, typically preceded with an asterisk key.

The present disclosure eliminates the need to dial an ‘*’ or “#” type prefixes to make a control code call. A pre-specified code length is used followed by a pre-specified time to determine the status of dialed digits as control call numbers. In a preferred embodiment, a two digit code is used followed by a pause of two seconds to recognize the entered two digits as control code calls. User inputs numbers which are converted into dtmf sounds and recognized by the system. The logic then determines how much time has passed since the last digit was entered. If two seconds pass and no further actions are taken, the system recognizes the entry of numbers as a control plane call. A few examples are listed below. A person skilled in the art will recognize that these examples are not exhaustive and are included for demonstrative purposes only.

Examples include commands such as: Extension 10 speaks a directory of the names of people on a list such as “Mary is 11, Sue is 12 etc”; extensions 11-69 can be reserved for the group members; extension 70 speaks/assigns speed dial names and offers search by name; extensions 71-79 are for the 9 speed dials; extension 80 speaks instructions for the 80 series of commands such as “Welcome to the help system for the device features. For ‘do not disturb’ press 81, for call forwarding press 82, for distinctive dialing press 83, for call history press 84, for ringing additional numbers press 85 to join the conference bridge press 88, for time functions press 89.” Further examples of the command structure may include, the 90 series of commands used to handle group functions such as, “To call a group huddle press 99, to make a group announcement press 98, to do a group page press 97, to do a group vote press 96.”

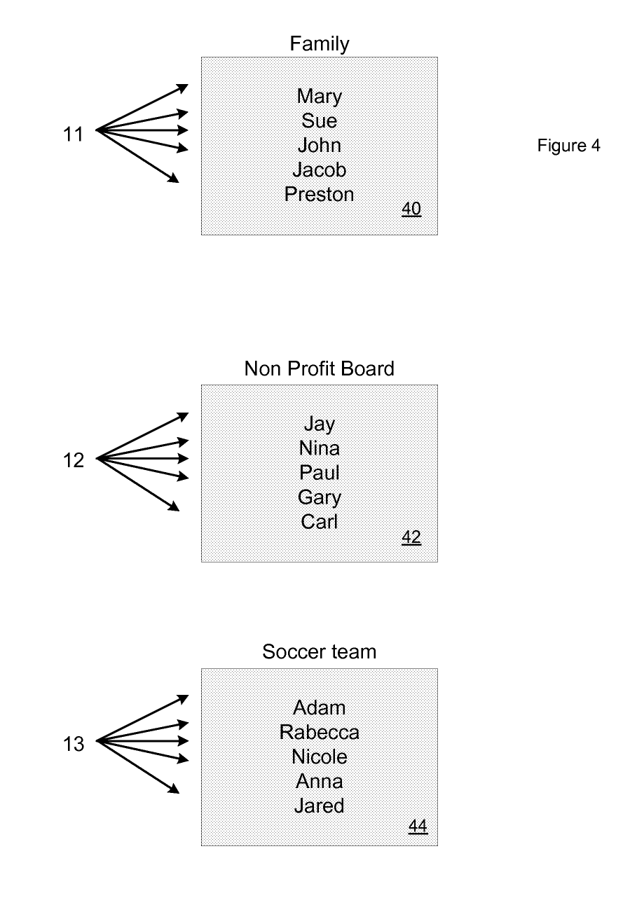

One advantage of the present technological disclosure is the ability to make group calls with the push of two buttons. FIG. 4 illustrates a preferred embodiment of the connection of a specified group with a group of two digit numbers. User can press ‘11’ and call his family 40 simultaneously. The pressing of the digits 11 will make simultaneous outgoing calls to everyone on the family list. A pre-specified code length is used followed by a pre-specified time to determine the status of dialed digits as control call numbers. In another example, the same user can choose to press the digits ‘12’ connecting the user to his non-profit board members 42. Similarly pressing the numbers ‘13’ connects the user to all the kids' parents on his daughter's soccer team 44. The calling occurs simultaneously so that everyone can be conferenced in at the same time as opposed to having to wait for everyone to dial in.

The present technological disclosure includes a uniform dial plan that offers the same prompts for all customers. In a preferred embodiment, the real time dial plan directly connects to the switching engine. This means that all phone switching is based on customer configured database contents, and therefore all servers are identical. Therefore same numbers can be used to customize different phone lists for different users. For example, the user in FIG. 4 has put all his family members on the number ‘11’. Another user can use the number ‘11’ to talk to his best friends from high school together. Since the same numbers can be sued by different users to create dynamic lists, the user can choose the numbers that are more meaningful to the user so that he will remember it. User frustration is eliminated because the user does not have to dial 30 digits to talk to three people.

### SOME PARTICULAR EMBODIMENTS

The present invention may be practiced as a method or device adapted to practice the method. The invention may be an article of manufacture such as media impressed with logic to carry out computer-assisted programs. One embodiment is a method of eliminating the need for prefixes when recognizing the input dtmf sounds as control code calls. This embodiment includes receiving a dynamic input from a VOIP device. The logic running on the server determines a time deferential after the input has been entered and recognizes the input as a command order if the time deferential condition is met. The command order is then matched to a plurality of control commands in a database. The output is the control command associated with the command order in the database.

In alternate embodiments, dynamic input includes dtmf sounds.

One aspect of the present invention, applicable to any of the embodiments above, is that the time deferential is at least two seconds. In another embodiment, command order includes a string variable used to match to the correct control command.

In yet another embodiment, a method of simplifying conference calls with groups is described. This embodiment includes assigning a list of phone numbers with a group call identifier. The group call identifier is then stored in a database. An input from the calling device is received. Subsequently, the input is matched with the group call identifier. Simultaneous calls are placed from the server to all the list of phone numbers associated with said group identifier. The list of phone numbers associated with the group identifier is then connected with the calling device. A person with ordinary skill in the art understands that there can be several group identifiers connected to different lists.

One aspect of the present invention, applicable to any of the embodiments above, is that group call identifier includes a two digit number. In another embodiment, group call identifier is dynamic and accepts data from a user.

Any of the methods described above or aspects of the methods may be embodied in a device adapted to of simplifying conference calls with groups. The said device may include a VOIP device connected to a routing server. A database is connected to the routing server consisting of a plurality of group call identifiers. The routing server is also connected to an input module. The input module is in turn connected to a processor and the database. The processor determines the match between an input and said group call identifiers

In alternate embodiments, VOIP device is the system initiating the call. A person skilled in the art will recognize that several hundreds to thousands of VOIP devices can be connected to the server initiating call requests.

One aspect of the present invention, applicable to any of the embodiments above, is that said group call identifiers are linked to a list of call numbers provided by the user.

In another embodiment, the input module accepts dtmf sounds as input.

While the present invention is disclosed by reference to the preferred embodiments and examples detailed above, it is understood that these examples are intended in an illustrative rather than in a limiting sense. Computer-assisted processing is implicated in the described embodiments. It is contemplated that modifications and combinations will readily occur to those skilled in the art, which modifications and combinations will be within the spirit of the invention and the scope of the following claims.

We claim as follows:

1. A method of eliminating the need for prefixes for placing control code calls, comprising:
receiving a dynamic input;
determining a time deferential after the input has been entered;
recognizing the input as a command order if the time deferential condition is met;
matching the command order to a plurality of control commands in a database, and output the control command associated with the command order in the database.

2. The method of claim 1, wherein said dynamic input includes dtmf sounds.

3. The method of claim 1, wherein said time deferential is at least two seconds.

4. The method of claim 1, wherein said command order includes a string variable used to match to the correct control command.

5. A method of simplifying conference calls with groups, comprising:
assigning a list of phone numbers with a group call identifier;
storing the group call identifier in a database;
receiving an input from a calling device;
matching said input with the group call identifier;
placing simultaneous calls from the server to all the list of phone numbers associated with said group identifier, and
connecting the list of phone numbers with the calling device.

6. The method of claim 5, wherein said group call identifier includes a two digit number.

7. The method of claim 5, wherein said group call identifier is dynamic and accepts data from a user.

8. The method of claim 5, wherein the input may include dtmf sounds.

9. A system of simplifying conference calls with groups, comprising:
a VOIP device connected to a routing server;
a database connected to the routing server consisting of a plurality of group call identifiers;
an input module connected to the routing server;
a processor connected to the database and the input module, and said processor determining the match between an input and said group call identifiers.

10. The method of claim 9, wherein said VOIP device is the system initiating the call.

11. The method of claim 9, wherein said group call identifiers are linked to a list of call numbers.

12. The method of claim 9, wherein said input module accepts dtmf sounds as input.
